(19) United States
(12) Patent Application Publication
(10) Pub. No.: US 2025/0280406 A1
(43) Pub. Date: Sep. 4, 2025

(54) SYSTEMS AND METHODS FOR IDENTIFYING BEAMS AND ASSOCIATED TIME

(71) Applicant: ZTE CORPORATION, Shenzhen (CN)

(72) Inventors: Shuang ZHENG, Shenzhen (CN); Nan ZHANG, Shenzhen (CN); Wei CAO, Shenzhen (CN); Ziyang Li, Shenzhen (CN); Hanqing XU, Shenzhen (CN)

(73) Assignee: ZTE CORPORATION, Shenzhen (CN)

(21) Appl. No.: 19/195,090

(22) Filed: Apr. 30, 2025

Related U.S. Application Data
(63) Continuation of application No. PCT/CN2022/129408, filed on Nov. 3, 2022.

(51) Int. Cl. H04W 72/044; H04W 72/0446; H04W 72/231

(52) U.S. Cl. CPC H04W 72/046; H04W 72/0446; H04W 72/231

(57) ABSTRACT

Presented are systems and methods for identifying beams and associated time. A network node may receive beam information used for a first forwarding link between a wireless communication device and the network node, from a wireless communication node. The beam information can be associated with a plurality of beams.

### CROSS-REFERENCE TO RELATED APPLICATION

This application claims the benefit of priority under 35 U.S.C. § 120 as a continuation of PCT Patent Application No. PCT/CN2022/129408, filed on Nov. 3, 2022, the disclosure of which is incorporated herein by reference in its entirety.

### TECHNICAL FIELD

The disclosure relates generally to wireless communications, including but not limited to systems and methods for identifying beams and associated time.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A network node (e.g., a secondary node (SN)) may receive beam information used for a first forwarding link (e.g., an access link) between a wireless communication device and the network node, from a wireless communication node (e.g., a BS). The beam information can be associated with a plurality of beams. The beams for the network node on the first forwarding link may include a first type of beams and a second type of beams. The beam information may include at least one of following information: a beam index; a beam pattern index; a bit flag to indicate the beam index or the beam pattern index; or a beam number. The beam number can be used to indicate the number of beams in each indication.

In some embodiments, the beam index may include at least one of an index of the first type of beams, an index of the second type of beams or the bit flag to differentiate the first type of beams or second type of beams.

In some embodiments, the network node may receive a list from the wireless communication node. The list may include one or a plurality of beam information and one or a plurality of associated time information. The list can be indicated to the network node by at least one of RRC signaling, MAC CE, or DCI signaling. A new field can be added in the DCI signaling to indicate the beam information and associated time information simultaneously. One of existing fields in the DCI signaling can be reused to indicate the beam information and associated time information simultaneously.

In some embodiments, one of existing bits in the DCI signaling or a newly added bit in the DCI signaling can be used to indicate whether the existing field is for a legacy use or for the beam information and associated time information. The associated time information of beam can be indicated to the network node.

In some embodiments, the beam information and the associated time information can be indicated to the network node via a same signaling or different signalings. A new field can be added in a DCI signaling to indicate the beam information for the first forwarding link. One of existing fields in a DCI signaling can be reused to indicate the beam information for the first forwarding link. One of existing bits in a DCI signaling or a newly added bit in the DCI signaling can be used to differentiate indicate whether the existing field is for a legacy use or for the beam information for the first forwarding link.

In some embodiments, a new field can be added in a DCI signaling to indicate the associated time information for the first forwarding link. One of existing fields in a DCI signaling can be reused to indicate the associated time information for the first forwarding link. One of existing bits in the DCI signaling or a newly added bit in the DCI signaling can be used to indicate whether the existing field is for a legacy use or the associated time information for the first forwarding link.

In some embodiments, a wireless communication node may transmit beam indication used for a first forwarding link between a wireless communication device and a network node, to the network node. The beam indication can be associated with a plurality of beams.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example network controlled repeater (NCR), in accordance with some embodiments of the present disclosure; and

FIG. 4 illustrates a flow diagram for identifying beams and associated time, in accordance with an embodiment of the present disclosure.

### DETAILED DESCRIPTION

### 1. Mobile Communication Technology and Environment

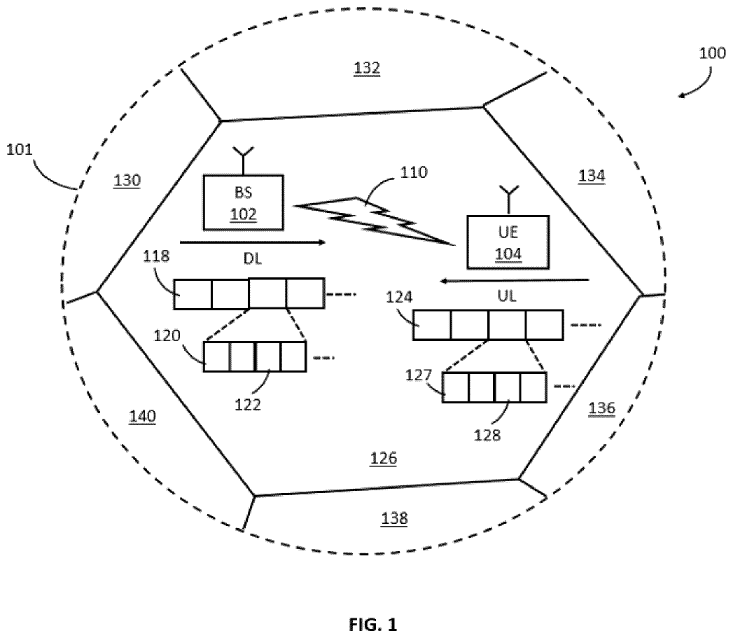

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

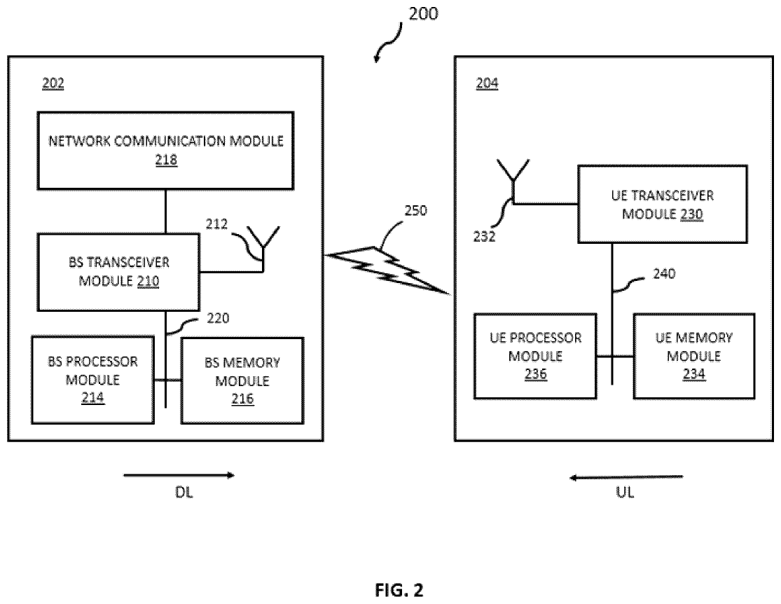

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (CNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Identifying Beams and Associated Time

As the new radio (NR) system moves to higher frequencies (around 4 GHz for FR 1 deployments and above 24 GHz for FR 2), propagation conditions may degrade compared to lower frequencies, which exacerbates coverage challenges. As a result, further densification of cells may be one solution. While a deployment of regular full-stack cells is preferred, it may not be an economically viable option. To provide blanket coverage in cellular network deployments with relatively low cost, radio frequency (RF) repeaters with full-duplex amplify-and-forward operation may be used in 2G, 3G, and/or 4G systems. However, a major problem brought by the RF repeater can be that the RF repeater amplifies both signal and noise, and may increase interference in the system.

Another property of the NR systems can be the use of multi-beam operation with associated beam management in the higher frequency bands defined for time division duplex (TDD). The multi-antenna techniques including massive multiple-input multiple-output (MIMO) for FR1 and analog beamforming for FR2 assist in coping with the challenging propagation conditions of these higher frequency bands. The RF repeater without beam management functions may not provide beamforming gain in its signal forwarding.

To cope with the unwanted interference, a network controlled repeater (NCR) can be considered, which makes use of a control information from its connected base station (BS) to enable an intelligent amplify-and-forward operation. In this disclosure, a method for beam information indication and associated time indication is investigated for a cellular network with the NCR.

RF repeaters may be used in 2G, 3G and/or 4G deployments to supplement the coverage provided by regular full-stack cells with various transmission power characteristics. The RF repeaters may provide a simple and cost-effective way to improve network coverage. The main advantages of RF repeaters can be their low-cost, their case of deployment, and the fact that the RF repeaters do not increase latency. The main disadvantage can be that the RF repeaters amplify signal and noise. Hence, the RF repeaters may contribute to an increase of interference (e.g., pollution) in the system. Within the RF repeaters, there can be different categories depending on power characteristics and an amount of spectrum that the RF repeaters are configured to amplify (e.g., single band or multi-band). The RF repeaters can be non-regenerative type of relay nodes. The RF repeaters may simply amplify-and-forward signal in an omnidirectional way.

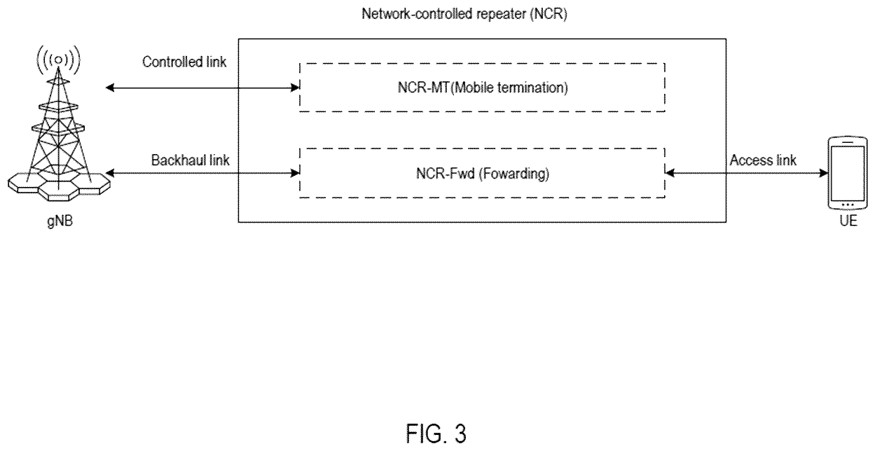

From perspective of functionality, a structure of network controlled repeater (NCR) is illustrated in FIG. 3. The NCR-mobile termination (MT) is defined as a function entity to communicate with a gNB via a control link (C-link) to enable exchange of control information (e.g., side control information at least for a control of NCR-Fwd). The C-link is based on NR Uu interface. The NCR-forwarding (Fwd) is defined as a function entity to perform the amplify-and-forwarding of uplink/downlink (UL/DL) RF signal between a gNB and a UE via a backhaul link and an access link. The behavior of the NCR-Fwd may be controlled according to received side control information from the gNB.

### Implementation Example 1: Beam Numbering Mechanism

A beam index can be used to indicate the beam information for an access link. There can be different types of beams on the access link. Different numbering mechanisms can be considered to index physical beams on the access link.

In some embodiments, a unified numbering mechanism can be considered for the beams of access link. For example, there can be 4 narrow beams and 2 wide beams of access links for a NCR. These 6 beams can be uniformly numbered from beam 1 to beam 6. In this case, the BS can directly use the index number to indicate the beam information to the NCR. For example, if the BS wants to indicate the beam 2 to the NCR, the BS may directly use the “0010” to represent the index of beam 2.

In some embodiments, the NCR may have different type of beams including a first type of beam (e.g., wide beam) and a second type of beam (e.g., narrow beam). The different types of beams can be numbered separately. The unified numbering mechanism can be used to index all the first type of beams. And the unified numbering mechanism can be used to index all the second type of beams. In such case, in order to differentiate the different type of beams, a bit can be used as a flag to differentiate the indicated index information refers to the first type of beam or the second type of beam. In this case, the beam index definition of a beam includes the bit flag information together with the numbering/index information of beam. And this beam index can be used for the beam information indication. For example, there can be 4 narrow beams and 2 wide beams of access links for a NCR. The wide beams can be numbered by 0˜1, and narrow beams can be numbered by 0˜3. The bit flag can be used to differentiate the type of beams, where the bit 0 may represent the wide beam and the bit 1 may represent the narrow beam. In this case, if the BS wants to indicate the narrow beam 2 to the NCR, the BS can use the bit information “110” as the beam index of the narrow beam 2, where the first bit can be the bit flag, the last two bits can be the numbering/index information of narrow beam 2. In some embodiments, the bit flag can be indicated by the BS to the NCR via at least one of: a radio resource control (RRC) signaling, a media access control control element (MAC CE) signaling, or a downlink control information (DCI) signaling. The indication of the bit flag and the numbering/index information of the beam can be in a same signaling or the different signalings. In some embodiments, the bit flag can be indicated with the numbering/index information of the beam in a same field of the signaling, where one of a bit in this field (e.g., the first bit) can be used as a bit flag to differentiate the type of indicated beam and the remaining bits in this field can be used to indicate the numbering/index information of a beam.

In some embodiment, a group numbering mechanism can be considered for the beams on the access link. The beams of NCR can be divided into different beam groups. Each beam group may include one first type of beam (e.g., a wide beam) and multiple second type of beams (e.g., narrow beams). In this case, a group numbering method can be used to number the beams of NCR with at least one of following methods.

Alt 1: all the first type of beams can be unified numbered, and the multiple second type of beams in each group can be unified numbered. In order to indicate the beam information, the first bits part including one or more bits can be used to indicate the numbering/index information of the first type of beam, and the second bits part including one or more bits can be used to indicate the numbering/index information of the second type of beam. These two bits part can be indicated via at least one of: a RRC signaling, a MAC CE signaling, or a DCI signaling. The two part of bits can be indicated in a same field of the same signaling, or in different fields of the same signaling, or different signalings. In some embodiments, a bit can be used as a flag to represent the indicated beam information for indicating the numbering/index information of the first type of beam or the numbering/index information of the second type of beam. For example, if the bit flag is 0, it may indicate that the indicated beam information is the first type of beams while the bit flag 1 may represent the second type of beams. In some embodiment, if the bit flag means/indicates the first type of beam, there may be no need to configure the second bits part. And if the value of the bit flag means/indicates the second type of beams, these two bits part may be both needed. In this case, the beam index definition include at least one of: the numbering/index information of the first type of beams, the numbering/index information of the second type of beams, the bit flag information. This beam index can be used for the beam information indication.

Alt 2: all the different group can be unified numbered, and the multiple second type of beams in each group can be unified numbered. There can be no need to number the first type of beam in each group since the numbering/index information can implicitly indicate the numbering/index information of the first type of beam. In order to indicate the beam information, the first bits part including one or more bits can be used to indicate the numbering/index information of the group, and the second bits part including one or more bits can be used to indicate the numbering/index information of the second type of beam. These two bits part can be indicated via at least one of: a RRC signaling, a MAC CE signaling, or a DCI signaling. The two bits part can be indicated in a same field of the same signaling, or in different fields of the same signaling, or different signalings. In some embodiments, a bit can be used as a flag to represent the indicated beam information for indicating the numbering/index information of the group or the numbering/index information of the second type of beam. For example, if the bit flag is 0, it may indicate that the indicated beam information is the numbering/index information of the group while the bit flag 1 may represent the numbering/index information of the second type of beam. In some embodiment, if the bit flag means/indicates the numbering/index information of the group, there may be no need to configure the second bits part. And if the value of the bit flag means/indicates the numbering/index information of the second type of beam, these two bits part may be both needed. Similarly, the beam index definition include at least one of: the numbering/index information of the group, the numbering/index information of the second type of beams, the bit flag information. This beam index can be used for the beam information indication.

In some embodiments, the beam indices on access link can be reported by the NCR. The beam indices on access link can be configured by the BS to the NCR, or can be configured by the OAM.

In some embodiment, the beams used on the access link of NCR-Fwd may be different from the beams supported on the access link of NCR-Fwd. The above mentioned beam numbering mechanism can be used to index the beams supported on the access link of NCR-Fwd, and/or can also be used to index the beams used or configured for the access link of NCR-Fwd. In some embodiments, the NCR can report the beam indices of all supported beams on the access link to the BS, or the OAM can configure the beam indices of all supported beams on the access link to the BS and NCR. If the BS indicates to the NCR that a sub-set of beams can be used on the access link, at least one of following methods can be considered for the index of the sub-set of beams.

Alt1: the BS can directly re-index the sub-set of beams used on the access link, and may indicate to the NCR the mapping relationship between the new index of the sub-set of beams and the index of the sub-set of beams. For example, there can be 4 wide beams indexed by 0˜3 and 8 narrow beams indexed by 0˜7. If the BS configures to the NCR that sub-set of beams including wide beams 2˜3 and narrow beams 4˜7 can be used on the access link, the BS can re-index the sub-set of beams to wide beams 0˜1 and narrow beams 0˜3, and may indicate the mapping relationship between the new index of sub-set of beams and the index of the sub-set of beams. The BS can directly use the new index to indicate the corresponding beams. In this case, the signaling cost can be reduced since there may only need one bit to indicate the wide beams and 2 bits to indicate the narrow beams while 2 bits to indicate the wide beams and 3 bits to indicate the narrow beams if the BS directly use the index without re-indexing the sub-set of beams.

Alt2: there can be no need to re-index the sub-set of beams. The BS may directly use the corresponding beam index of each beam to indicate the beam information.

### Implementation Example 2: Applicable Time Information of Beam

The BS can indicate the beam information to the NCR. With the received beam information, the NCR can forward the signal using the corresponding beam. The NCR's beam can be represented/identified by a beam index or a TCI state. In each indication, one or a plurality of beams can be indicated. There can be three options considering the beam indication method.

Option 1: the BS may indicate one or a plurality of beams in each indication. The beam in the indication can be represented/identified by the beam index or the TCI state. The beam index definition can be determined according to different beam numbering mechanism shown in the implementation example 1.

Option 2: the BS can indicate one or a plurality of beam patterns in each indication. The beam pattern can be an ordered sequence of NCR's beams to be used one by one. The beam in the beam pattern can be represented/identified by the beam index or the TCI state. The beam index definition can be determined according to different beam numbering mechanism shown in the implementation example 1. The beams in the each beam pattern can be same or different. If all beams in a beam pattern is the same, it may indicate that the beam pattern includes only one beam.

Option 3: the BS can configure an applicable beam list including one or more beam patterns. The beam in the beam pattern can be represented/identified by a beam index or a TCI state. The beam index definition can be determined according to different beam numbering mechanism shown in the implementation example 1. Each beam pattern in the list can have a corresponding beam pattern index. The beams in the each beam pattern can be same or different. If all beams in a beam pattern is same, it may indicate that the beam pattern includes only one beam. The BS can directly indicate one or a plurality of beam pattern indices to the NCR in each indication.

In addition to the beam information, the associated time domain information of the beam information can be indicated by the BS to the NCR. In some embodiments, the time domain information can be used to indicate an applicable time for the NCR's other operations (e.g., power control, on/off). The time domain information can include at least one of following aspects: (1) parameters related to time resource of beam information; (2) a time offset; (3) a time granularity; or (4) a periodicity.

The time offset can be a time gap between a BS's control information transmission and an NCR's earliest applicable forwarding time after received the control information. The BS can configure the time offset including a slot level value K1 and/or a symbol level value K2 to the NCR. In some embodiments, the configuration of K2 can be omitted. For example, the BS may transmit the indication of beam information to the NCR. The transmission of the indication may end in slot n. The time offset can be the symbol K2 in the slot n+K1. In certain embodiments, both K1 and K2 can be zero. In such a case, the beam can be applied (with the time domain information) by the NCR upon the reception of the beam information (e.g., from the slot n).

As for the parameters related to time resource of beam information, different parameters can be considered with different beam indication cases. As for the beam pattern case, the NCR can know a start time and a duration of the beam pattern. The time length of each beam in the beam pattern may also be known by the NCR. Following two cases can be considered with the applicable time information for the beam pattern case.

Case 1: time resource of the beam pattern when the beams in the beam pattern are used continuously.

In this case, the beams in the beam pattern can be used one by one continuously without time gap. The time domain information of the beam pattern can include at least one of: (1) parameters related to the time resource of the beam pattern; (2) a time offset; 3) a time granularity; or (4) a periodicity. As for the parameters related to the time resource of the beam pattern, it may include the start time and the duration of the beam pattern. In some embodiments, the time length of each beam in the beam pattern may also be indicated.

First, the time length of each beam in the beam pattern can have at least one of following alternatives.

Alt 1: a default time length. The default time length may represent the time length applicable for all beams in the beam pattern. This default time length can be pre-defined, and may be known by the NCR and/or the gNB.

Alt 2: a time length. The time length can be applicable for all beams in the beam pattern can be indicated by the BS to the NCR;

Alt 3: a plurality of time lengths. Each of the plurality of time lengths can be associated with a beam in the beam pattern, which can be indicated by the BS to the NCR.

Alt 4: a plurality of time lengths. Each of the plurality of time lengths can be associated with multiple beams in the beam pattern, which can be indicated by the BS to the NCR.

Second, the start time and the duration of the beam pattern can be indicated by at least one of: a start time, an end time, a start and length indicator value (SLIV), or a duration of the beam pattern.

A start time can be used to indicate the start time of the beam pattern. The start time can be indicated via a start slot and/or a start symbol. The start time of the beam pattern in the time domain information may include a start slot index (e.g., Sslot) and/or a start symbol index (e.g., Ssymbol). In some embodiments, the start time can be implicitly indicated, or can follow a pre-defined rule if no explicit indication value of start time. For example, if the BS does not indicate the start time to the NCR and the BS indicates the time offset to the NCR (e.g., time offset parameters K1 and/or K2), the start time of the indicated beam information can be the symbol K2 in the slot n+K1. For instance, if the BS does not indicate the start time to the NCR and the BS indicates the time offset to the NCR (e.g., time offset parameters K1 and/or K2), the NCR may start the forwarding operation using the indicated beam from X (X≥1) slot(s) after the applicable time defined by the time offset, where the X can be pre-defined to the NCR and BS, or can be indicated by the BS to the NCR.

An end time can be used to indicate the end time of the beam pattern. The end time can be indicated via an end slot and/or an end symbol. The end time of the beam pattern in the time domain information may include an end slot index (e.g., Eslot) and/or an end symbol index (e.g., Esymbol).

The duration of the beam pattern may include a slot number and/or a symbol number. The duration can include a plurality of slot indexes and/or a plurality of symbol indexes.

The start time and the duration of the beam pattern can be indicated by a combined parameter. A start and length indicator value (SLIV) can be defined for a duration with a pre-defined maximum time length. If the duration is not more than a slot, the start symbol Ssymbol and the duration of the beam pattern (e.g., a symbol number of Lsymbol) can be indicated using a start and length indicator value (SLIV). If the duration is with a slot level granularity and not more than a subframe, the start slot Sslot and the duration (e.g., a symbol number of Lslot) can be indicated using a SLIV.

Specifically, the above mentioned parameters can be combined together to indicate the start time and duration of the beam pattern. At least one of following options can be listed as an example.

OP 1.1 (start time): the BS can only indicate the start time to the NCR, as for the duration of the beam pattern, it can be implicitly indicated by the sum of the time length of each beam in the beam pattern.

OP 1.2 (time offset): the start time of the beam pattern can be implicitly indicated by the time offset. As for the duration of the beam pattern, it can be implicitly indicated by the sum of the time length of each beam in the beam pattern.

OP 1.3 (start time+duration): the BS can indicate the start time and the duration of the beam pattern to the NCR. In such case, the duration of the beam pattern can be equal to the sum of the applicable time length of each beam in the beam pattern.

OP 1.4 (start time+end time): the BS can indicate the start time and the end time to the NCR. And the time interval between the start time and the end time should be equal to the sum of the applicable time length of each beam in the beam pattern.

OP 1.5 (end time): the BS can only indicate the end time to the NCR, and the start time can be implicitly indicated by the time offset if the time offset is indicated to the NCR. If the BS does not indicate the time offset to the NCR, it may mean/indicate that the NCR can forward the signal using the beam pattern upon the reception of the beam information.

OP 1.6 (SLIV): the BS can indicate a SLIV value to the NCR to represent the start time and the duration of the beam pattern. The duration calculated by the SLIV can be equal to the sum of the applicable time length of each beam in the beam pattern.

In some embodiment, as for the applicable time information of the beam pattern, the BS can only indicate the applicable time length of each beam in the beam pattern to the NCR and the mechanisms of the applicable time length of each beam can be the same as the Alt1-Alt4 in the case 1 of implementation example 2. As for the start time of the beam pattern, it can be implicitly indicated by the time offset, or the NCR can forward the signal using the beam pattern upon the reception of the beam information if the time offset is not configured to the NCR. The duration of the beam pattern can be implicitly indicated by the sum of the applicable time length of each beam in the beam pattern.

Case 2: the parameters related to the time resource of the beam pattern when the beams in the beam pattern are not used continuously.

In this case, the applicable time of each beam in the beam pattern may not be used continuously, which may mean/indicate the applicable time of the adjacent beams in the beam pattern may have the time gap. Similarly, the time information of the beam pattern can include at least one of: (1) parameters related to the time resource of the beam pattern; (2) a time offset; (3) a time granularity; or (4) a periodicity. As for the parameters related to the time resource of the beam pattern in this case 2, at least one of following two options can be considered.

Option 1: separate time resource parameters for each beam in the beam pattern.

Since the beams in the beam pattern are not used continuously in this case 2, the time parameters can be defined for each beam in the beam pattern. For each beam of the beam pattern, the time resource information of each beam can be indicated by at least one of: a start time, an end time, a duration of a beam, or a SLIV.

A start time can be used to indicate the start time of a beam and can be indicated via a start slot and/or a start symbol. The start time of a beam in the time domain information may include a start slot index (e.g., Sslot) and/or a start symbol index (e.g., Ssymbol). The start time of the first beam in the beam pattern may be not earlier than the time offset of the beam pattern. In some embodiments, the start time of the first beam in the beam pattern can be implicitly indicated by the time offset, or may follow a pre-defined rule if no explicit indication value of start time. For example, if the BS does not indicate the start time of the first beam in the beam pattern to the NCR and the BS indicates the time offset of the beam pattern to the NCR (e.g., time offset parameters K1 and/or K2), the start time of the first beam in the beam pattern can be the symbol K2 in the slot n+K1. For another example, if the BS does not indicate the start time to the NCR and the BS indicates the time offset to the NCR (e.g., time offset parameters K1 and/or K2), the NCR may start the forwarding operation using the indicated beam from X (X≥1) slot(s) after the applicable time defined by the time offset, where the X can be pre-defined to the NCR and BS, or can be indicated by the BS to the NCR.

An end time can be used to indicate the end time of a beam and can be indicated via an end slot and/or an end symbol. The end time of a beam in the time domain information may include an end slot index Eslot and/or an end symbol index Esymbol.

The duration of a beam may include a slot number and/or a symbol number. The duration can include a plurality of slot indexes and/or a plurality of symbol indexes.

The start time and the duration of a beam can be indicated by a combined parameter. A start and length indicator value (SLIV) can be defined for a duration with a pre-defined maximum time length. If the duration is not more than a slot, the start symbol Ssymbol and the duration of the beam pattern (e.g., a symbol number of Lsymbol) can be indicated using a start and length indicator value (SLIV). If the duration is with a slot level granularity and not more than a subframe, the start slot Sslot and the duration (e.g., a symbol number of Lslot) can be indicated using a SLIV.

Specifically, the above mentioned parameters can be combined together to indicate the start time and duration of a beam. At least one of following options can be listed as an example.

Alt 1.1: start time+end time.

Alt 1.2: start time+duration.

Alt 1.3: SLIV.

Alt 1.4: time offset+duration. In this case, the start time can be implicitly indicated by the time offset.

Alt 1.5: duration.

Option 2: The time related parameters and mechanisms can be the same as the case 1 of implementation example 2. In addition to the parameters and mechanisms mentioned in the case 1 of implementation example 2, considering that the beams in the beam pattern may not be used sequentially, the time gap between the adjacent beams in the beam pattern can be indicated to the NCR with at least one of following alternatives.

Alt 2.1: a default time gap. The default time gap may mean/indicate that the time interval between all the two adjacent beams in the beam pattern is same, is pre-defined, and/or known by the NCR and the gNB.

Alt 2.2: a time gap. The time gap may mean/indicate that the time interval between all the two adjacent beams in the beam pattern is same. The time gap can be indicated by the BS to the NCR.

Alt 2.3: a plurality of time gap, where each time gap of the plurality of time gap can be associated with two adjacent beams in the beam pattern. The plurality of time gap can be indicated by the BS to the NCR.

### Implementation Example 3: Signaling of Beam Information and Associated Time Information for Access Link

Case 1: single beam or multiple beams per indication.

As for the single beam or multiple beams per indication, the signaling of the beam information and the associated time information can have at least one of following options. And the beam information includes the beam index, where the beam index definition can be determined according to different beam numbering mechanism shown in the implementation example 1.

Op 1.1: the beam information and the associated time information can be separately indicated in different fields.

First, as for the beam information indication, the beam information including one or a plurality of beams can be indicated by the BS to the NCR via at least one of: a new information element (IE) in the RRC signaling, a new MAC CE signaling or a DCI signaling.

Second, as for the associated time information, the associated time information including one or a plurality of time resource information can be indicated by the BS to the NCR via at least one of: a new IE in the RRC signaling, a new MAC CE signaling or a DCI signaling.

Third, the BS may indicate an association between the beam information and the time domain information to the NCR via a RRC/MAC CE/DCI message. The association may refer to (1) via same signaling for indication of the beam (e.g., beam information) and indication of the associated time; or (2) with a defined mapping relationship. For example, the BS may indicate a one-to-N (with N>=1) mapping between the beam information and the time domain information. For another example, if the NCR supports communication with multiple beams at the same time, the BS may indicate an N-to-one (with N>=1) mapping between the beam information and the time domain information.

Op 1.2: the beam information and the associated time information can be jointly indicated.

A list including one or more forwarding resources can be indicated by the BS to the NCR via at least one of: a new IE in the RRC signaling, a new MAC CE signaling or DCI signaling. Each forwarding resource in the list may have at least one of: a beam information or an associated time resource.

In some embodiment, a list including one or a plurality of beam information and one associated time information can be indicated by the BS to the NCR via at least one of: a new IE in the RRC signaling, a new MAC CE signaling or a DCI signaling. In this case, the only time resource information can be common for all beam information in the list, which may mean/indicate the beams configured in the list are used simultaneously.

In some embodiment, a list including one beam information and one or a plurality of time information can be indicated by the BS to the NCR via at least one of: a new IE in the RRC signaling, a new MAC CE signaling or a DCI signaling. In this case, the only beam in the list can be applicable with all configured time information in the list, which may mean/indicate the configured beam has multiple applicable time resource.

Case 2: beam pattern index per indication.

As for the beam pattern case, the BS can configure a list including one or more beam patterns, where each beam pattern in the list may include one or an ordered sequence of beams.

The beams in the beam pattern can be represented/identified by the beam index. The beam index definition can be determined according to different beam numbering mechanism shown in the implementation example 1. Each beam pattern in the list can have a corresponding beam pattern index. The beams in each beam pattern can be same or different. If all beams in a beam pattern is same, it may indicate that this beam pattern may include only one beam. The BS can directly indicate one or a plurality of beam pattern indices to the NCR in each indication.

Op 2.1: the beam patterns and associated time information can be configured in a same list.

A list of forwarding resources can be configured by the BS and can be indicated to the NCR. Each forwarding resource in the list can include at least one of: a beam pattern or associated time information. The list can include one or a plurality of forwarding resources. Each forwarding resource in the list may have a corresponding resource index. In some embodiments, all defined beam pattern in the list may have a same associated time information. In this case, this list can include one or a plurality of beam pattern and a time information resource. The resource index can be used to represent the different beam pattern. The BS can directly indicate the resource index to the NCR to represent the corresponding beam pattern. The associated time information can directly refer to the common time information resource defined in the list. In some embodiments, the list may have one beam pattern and one or a plurality of time information, which may mean/indicate that the beam pattern can be applied to different time. In this case, this list can include one or a plurality of time information resource and a common beam pattern. The resource index can refer to different time resource information. The BS can directly indicate the resource index to the NCR to represent the corresponding time information. The beam information can directly refer to the common beam pattern defined in the list.

In this case, the beam information and associated time information can be jointly indicated by the resource index in the list. At least one of following methods can be considered for the signaling of the beam information and associated time information.

Alt 1: this list can be indicated by the BS to the NCR via at least one of: a new IE in a RRC signaling, a MAC CE signaling, or a DCI signaling.

Alt 2: this list can be configured by the BS to the NCR via a new IE in the RRC signaling. A new MAC CE signaling or a DCI signaling can be used to indicate one or a plurality of resource indices in the list to represent the corresponding beam information and associated time information.

Alt 3: this list can be configured by the BS to the NCR via a new MAC CE signaling. A DCI signaling can be used to indicate one or a plurality of resource indices in the list to represent the corresponding beam information and associated time information.

Alt 4: this list can be configured by the BS to the NCR via a new IE in a RRC signaling. A new MAC CE signaling can be used to indicate a set of resource indices from the list. A DCI signaling can be used to indicate one or a plurality of resource index from the set of resource indices indicated by the MAC CE signaling.

Op 2.2: the beam pattern and associated time information can be separately configured.

The beam pattern and the associate time information can be separately indicated. First, as for the beam information, at least one of following methods can be considered.

Alt 1: the BS can directly indicate one or a plurality of beam patterns to the NCR via at least one of: a RRC signaling, a new MAC CE signaling or a DCI signaling.

Alt 2: the BS can indicate a list including one or a plurality of beam patterns. Each beam pattern in the list may have a beam pattern index. The BS can directly use the beam pattern index to indicate the beam information to the NCR. The beam information can be indicated by the BS to the NCR with at least one of following methods.

Alt 2.1: this list can be indicated by the BS to the NCR via at least one of: a new IE in a RRC signaling, a MAC CE signaling, or a DCI signaling.

Alt 2.2: this list can be configured by the BS to the NCR via a new IE in a RRC signaling. A new MAC CE signaling or a DCI signaling can be used to indicate one or a plurality of beam pattern indices in the list to represent the corresponding beam information.

Alt 2.3: this list can be configured by the BS to the NCR via a new MAC CE signaling. A DCI signaling can be used to indicate one or a plurality of beam pattern indices in the list to represent the corresponding beam information.

Alt 2.4: this list can be configured by the BS to the NCR via a new IE in a RRC signaling. A new MAC CE signaling can be used to indicate a set of beam pattern indices from the list. A DCI signaling can be used to indicate one or a plurality of beam pattern indices from the set of resource indices indicated by the MAC CE signaling.

Second, as for the time information, at least one of following methods can be considered.

Alt A: the BS can directly indicate one or a plurality of time information resources associated with the indicated beam information to the NCR via at least one of a new IE in a RRC signaling, a new MAC CE signaling, or a DCI signaling.

Alt B: the BS can configure a list including one or a plurality of time information. Each time information in the list can also have a resource index. The BS can directly use the resource index to indicate the time information to the NCR. The time information used by the indicated beams can be indicated by the BS to the NCR with at least one of following methods.

Alt B.1: this list can be indicated by the BS to the NCR via at least one of: a new IE in a RRC signaling, a MAC CE signaling, or a DCI signaling.

Alt B.2: this list can be configured by the BS to the NCR via a new IE in a RRC signaling. A new MAC CE signaling or a DCI signaling can be used to indicate one or a plurality of time resource indices in the list to represent the corresponding time information.

Alt B.3: this list can be configured by the BS to the NCR via a new MAC CE signaling. A DCI signaling can be used to indicate one or a plurality of time resource indices in the list to represent the corresponding time information.

Alt B.4: this list can be configured by the BS to the NCR via a new IE in a RRC signaling. A new MAC CE signaling can be used to indicate a set of time resource indices from the list. A DCI signaling can be used to indicate one or a plurality of time resource indices from the set of time resource indices indicated by the MAC CE signaling.

The beam information (e.g., beam pattern) and the associated time information can be indicated by the BS to the NCR in a same signaling. In some embodiments, the beam information and the associated time information can be indicated by the BS in the different signalings. For example, the BS can configure a beam pattern list and a time information list to the NCR in a same IE in the RRC signaling. The BS can directly use a MAC CE signaling to indicate a beam pattern index and a time resource index to the NCR to represent the beam information and the associated time information. For example, the BS can configure a beam pattern list and a time information list to the NCR in a same IE in the RRC signaling. The BS can use a first MAC CE signaling to indicate a set of the beam pattern indices from the beam pattern list, and can use a second MAC CE to indicate a set of a time resource indices from the time information list. A DCI signaling can be used by the BS to indicate one of the beam pattern index from the set of beam information indicated by the first MAC CE signaling and one of time resource index from the set of time information indicated by the second MAC CE signaling. For instance, the BS can configure a beam pattern list in a RRC signaling. The BS can use a MAC CE signaling to indicate a beam pattern index and the associated time resource information.

Case 3: The detailed signaling design of the beam information and the associated time information.

The DCI signaling can be used to indicate the beam information and the associated time information. The beam information indicated in the DCI can include at least one of following information.

(1) beam index: the beam index definition can be determined according to the beam numbering mechanism shown in the implementation example 1. In some embodiment, if the beams of NCR's access link has different type of beams, the beam index definition can include the beam flag information, which is used to differentiate the indicated index is for the first type of beams or the second type of beams;

(2) beam pattern index;

(3) a bit flag: the bit flag can be used to differentiate the indicated index in the DCI refers to the beam index or beam pattern index; or

(4) a beam number per indication: if the beam number per indication is 1, it may mean/indicate that a single beam index is indicated in this DCI; if the beam number per indication is more than 1, it may represent that multiple beams are indicated in this indication, which means/indicates a beam pattern index may be indicated in this DCI.

In some embodiments, the beam information indicated in the DCI can include at least one of following information.

(1) Beam number per indication. If the value of the beam number is 1, it may represent only a single beam index is indicated in the DCI. If the value of beam number is more than 1, it may represent that multiple beams are indicated and the indicated index in the DCI is the beam pattern index. The bit width may depend on the maximum number of beams in a beam pattern.

(2) Index information.

If the beam number per indication is 1, the indicated index information can be the beam index. The beam index definition can be determined according to the different numbering mechanism in the implementation example 1. The bit width may depend on the beam layout of NCR and the beam numbering mechanism.

If the beam number per indication is more than 1, the indicated index information can be the beam pattern index. A beam pattern list can be defined in the RRC signaling. A selected beam pattern index can be indicated in the DCI. In this way, the bit width can depend on the number of beam pattern in the list.

As for the detailed signaling design of DCI, at least one of following methods can be considered.

Op 3.1: the beam information and the associated time information can be indicated in a same field in the DCI. The beam information can be one or a plurality of beam indices or one or a plurality of beam pattern indices. The beam index definition can be determined according to the different numbering mechanism in the implementation example 1.

Since the beam information and the associated time information are indicated in a same list, the same field can be considered in the DCI signaling to simultaneously indicate the beam and associated time information. For example, as mentioned in the option 2.1 of case 2, the beam information and the associated time information can be configured in a same list. A resource index can be used to simultaneously indicate the corresponding beam information and time information. As for the detailed design of DCI signaling, at least one of following alternatives can be considered.

Alt 1: a new DCI format with a separate radio network temporary identifier (RNTI) can be defined for NCR-Fwd to indicate the one or a plurality of beam information and associated time information used for the access link. If a DCI is scrambled by the NCR-MT's RNTI, the NCR-MT may carry out communication with the BS (e.g., a UE with assigned time-frequency resource, MCS and/or other control parameters). If a DCI is scrambled by the NCR-Fwd's RNTI, the NCR-MT may decode a new DCI format for the NCR-Fwd and may control the NCR-Fwd's amplify-and-forward operation accordingly. The new DCI format for the NCR′Fwd may include at least one of following fields: (1) beam information for backhaul link: to indicate the beam information (e.g., TCI state ID) for the backhaul link; (2) time resource information for backhaul link: to indicate the associated time information for the indicated beam information; (3) beam information and associated time information for access link: use this field to simultaneously indicate the beam information and associated time information (e.g., a resource index shown in option 2.1 of case 2); (4) frequency resource information: to indicate the frequency resource to be used by the NCR-Fwd; or (5) panel resource information: to indicate the panel information to be used by the NCR-Fwd.

Alt 2: a new field can be added in the DCI signaling to simultaneously indicate the beam information and associated time information for the access link.

Alt 3: one of existing field in the DCI signaling can be used to simultaneously indicate the beam information and associated time information for the access link. One of existing bits in the DCI signaling can be used to indicate this field is for the legacy use or for the beam and time information indication. For example, the current “Frequency domain resource assignment” in the DCI signaling can be re-interpreted to indicate the beam information and the associated time information, where the first bit in the “Frequency domain resource assignment” can be used as a flag. If the first bit is set as 0, it may mean/indicate that the remaining bits in the “Frequency domain resource assignment” is used to indicate the frequency information used for NCR-MT. If the first bit is set as 1, it may mean/indicate that the remaining bits in the “Frequency domain resource assignment” is used to indicate the beam information and the associated time information for access link. For example, the current “Time domain resource assignment” or “Modulation and coding scheme”, or “Bandwidth part indicator” can be re-interpreted, and one of a bit in this field can be used as a flag.

Alt 4: one of existing field in the DCI signaling can be used to simultaneously indicate the beam information and associated time information for the access link. A new bit can be added in the DCI signaling to indicate this field is for the legacy use or for the beam and time information indication of access link. For example, the current “Modulation and coding scheme” in the DCI signaling can be re-interpreted to indicate the beam information and the associated time information, where a new bit can be added in the DCI signaling as a flag. If the new bit is set as 0, it may mean/indicate that the “Modulation and coding scheme” field is used to indicate the modulation and coding information used for NCR-MT. If the new bit is set as 1, it may mean/indicate that the “Modulation and coding scheme” field is used to indicate the beam information and the associated time information for access link.

Alt 5: the current “Transmission configuration indication” field can be re-interpreted to indicate the beam information and associated time information for the access link. One of a bit in the DCI signaling or a new bit can be added in the DCI signaling to indicate that this field is for the beam information for the control link or for the beam and time information indication of access link. In some embodiments, one of a bit in the DCI signaling or a new bit can be added in the DCI signaling to indicate that this field is for the beam information for a backhaul link or for the beam and time information indication of an access link.

Op 3.2: the beam information and the associated time information can be indicated separately in the different fields in the DCI. The beam information can be one or a plurality of beam indices or one or a plurality of beam pattern indices. The beam index definition can be determined according to the different numbering mechanism in the implementation example 1.

Since the beam information (e.g., the beam index or beam pattern index) and the associated time information are indicated in the different fields of the DCI signaling, the field in the DCI to indicate the beam information and the field in the DCI to indicate the time information can be considered separately.

(1) First, at least one of following methods can be considered to indicate the beam information for access link.

Alt 1: a new field can be added in the DCI signaling to indicate the beam information for the access link.

Alt 2: one of existing field in the DCI signaling can be used to indicate the beam information for the access link. One of existing bits in the DCI signaling can be used to indicate this field is for the legacy use or for the beam indication of access link. For example, the current “Frequency domain resource assignment” in the DCI signaling can be re-interpreted to indicate the beam information of access link, where the first bit in the “Frequency domain resource assignment” can be used as a flag. If the first bit is set as 0, it may indicate/mean that the remaining bits in the “Frequency domain resource assignment” is used to indicate the frequency information used for NCR-MT. If the first bit is set as 1, it may mean/indicate that the remaining bits in the “Frequency domain resource assignment” is used to indicate the beam information for access link. For example, the current “Time domain resource assignment” or “Modulation and coding scheme”, or “Bandwidth part indicator” can also be re-interpreted and one of a bit in this field can be used as a flag.

Alt 3: one of existing field in the DCI signaling can be used to indicate the beam information for the access link. A new bit can be added in the DCI signaling to indicate this field is for the legacy use or for the beam indication of access link. For example, the current “Modulation and coding scheme” in the DCI signaling can be re-interpreted to indicate the beam information of access link, where a new bit can be added in the DCI signaling as a flag. If the new bit is set as 0, it may mean/indicate that the “Modulation and coding scheme” field is used to indicate the modulation and coding information used for NCR-MT. If the new bit is set as 1, it may mean/indicate that the “Modulation and coding scheme” field is used to indicate the beam information for the access link.

Alt 4: the current “Transmission configuration indication” field can be re-interpreted to indicate the beam information for the access link. One of a bit in the DCI signaling or a new bit can be added in the DCI signaling to indicate that this field is for the beam information for the control link or for the beam indication of access link. In some embodiments, one of a bit in the DCI signaling or a new bit can be added in the DCI signaling to indicate that this field is for the beam information for the backhaul link or for the beam indication of the access link.

(2) Second, at least one of following methods can be considered for the associated time information of beams for the access link.

Alt 1: a new field can be added in the DCI signaling to indicate the associated time information of the indicated beam for the access link.

Alt 2: the current “Time domain resource assignment” field in the DCI signaling can be reused to indicate associated time information of the indicated beam for the access link. One of a bit in the DCI signaling can be used to indicate that the “Time domain resource assignment” field is for the time information used for NCR-MT or used for the associated time information for the access link. For example, the first bit in the “Time domain resource assignment” field can be used as a flag. If the first bit is set as 0, it may mean/indicate that the “Time domain resource assignment” field is used to indicate the time resource used for NCR-MT. If the first bit is set as 1, it may mean/indicate that the “Time domain resource assignment” field is used to indicate the associated time information of beams of the access link.

Alt 3: the current “Time domain resource assignment” field in the DCI signaling can be reused to indicate associated time information of the indicated beam of the access link. A new bit can be added in the DCI signaling to indicate that the “Time domain resource assignment” field is for the time information used for NCR-MT or used for the associated time information for the access link. For example, if the new bit is set as 0, it may mean/indicate that the “Time domain resource assignment” field is used to indicate the time resource used for NCR-MT. If the new bit is set as 1, it may mean/indicate that the “Time domain resource assignment” field is used to indicate the associated time information of beams of the access link.

(3) In some embodiments, a new DCI format with a separate radio network temporary identifier (RNTI) can be defined for NCR-Fwd to indicate the one or a plurality of beam indices used for the access link. If a DCI is scrambled by the NCR-MT's RNTI, the NCR-MT may carry out communication with the BS (e.g., a UE with assigned time-frequency resource, MCS, and/or other control parameters). If a DCI is scrambled by the NCR-Fwd's RNTI, the NCR-MT may decode the new DCI format for the NCR-Fwd, and may control the NCR-Fwd's amplify-and-forward operation accordingly. The new DCI format for the NCR-Fwd may include at least one of following fields: (1) beam information for backhaul link: to indicate the beam information (e.g., TCI state ID) for the backhaul link; (2) time resource information for backhaul link: to indicate the associated time information for the indicated beam information on backhaul link; (3) beam information for access link: to indicate the beam information (e.g., the beam index or beam pattern index) for the access link; (4) time resource information for access link: to indicate the associated time information of the indicated beam for access link; (5) frequency resource information: to indicate the frequency resource to be used by the NCR-Fwd; or (6) panel resource information: to indicate the panel information to be used by the NCR-Fwd.

### Implementation Example 4: Beam Indication for Backhaul Link of NCR

In some embodiments, a set of transmission configuration indication (TCI) states configured by the RRC signaling can be shared, and can be used for both control link and backhaul link. The MAC CE signaling can be used to activate a sub-set of TCI states from the TCI state configuration in a RRC signaling. This sub-set of TCI states activated by the MAC CE signaling can be shared, and can be used for the beam indication of control link and backhaul link. The value of N can be pre-defined for all NCRs, or the value of N can be different for different NCRs. The value of N can be determined according to NCR-MT's capability. The DCI signaling can be used to select a TCI state from the sub-set of TCI states activated by the MAC CE. In such case, a number of TCI states (e.g., the first N (N≥1) TCI states) in this activated sub-set of TCI states can be pre-defined for the BS and NCR to be used for the beam indication of backhaul link. In some embodiments, a number of TCI states (e.g., the first N (N≥1) TCI states) in this activated sub-set of TCI states can be indicated by the BS to the NCR to be used for the beam indication of backhaul link. Therefore, when the NCR receives the selected TCI state indicated by the DCI, the NCR may check whether the selected TCI state belongs to the applicable TCI states for the backhaul link. If the selected TCI state ID is in the applicable TCI states for the backhaul link, the selected TCI state can be used for the beam indication of the backhaul link and control link. If the selected TCI state ID does not belong to the applicable TCI states for the backhaul link, the selected TCI state can only be used for the beam indication for control link. For example, in some embodiments, there can be 8 TCI states activated by the MAC CE signaling. The BS may indicate to the NCR that only the first 4 TCI states activated in the MAC CE that can be used by the backhaul link. In this case, if the TCI field in the DCI is 2, it may indicate that this TCI state can be simultaneously configured for the beam indication of C-link and backhaul link. If the TCI field in the DCI is 5, it may indicate that the selected TCI state can only be applicable for the beam indication of C-link.

In some embodiments, the set of TCI states configured by the RRC signaling for the control link can be used for the backhaul link. A number of TCI states (e.g., the first N (N≥1) TCI states) in the RRC-configured TCI states set can be pre-defined for the BS and NCR to be used for the beam indication of backhaul link. The value of N can be pre-defined for all NCRs, or the value of N can be different for different NCRs. The value of N can be determined according to NCR-MT's capability. In some embodiments, a number of TCI states (e.g., the first N (N≥1) TCI states) in the RRC-configured TCI states set can be indicated by the BS to the NCR to be used for the beam indication of backhaul link. In this case, when the NCR receives the selected TCI state indicated by the DCI, the NCR may check whether the selected TCI state belongs to the applicable TCI states for the backhaul link. If the selected TCI state ID is in the applicable TCI states for the backhaul link, the selected TCI state can be used for the beam indication of the backhaul link and control link. If the selected TCI state ID does not belong to the applicable TCI states for the backhaul link, the selected TCI state can only be used for the beam indication for control link. For example, there can be 20 TCI states configured by the RRC signaling, and the BS may indicate to the NCR that only the first 8 TCI states configured in the RRC set that can be used by the backhaul link. In such case, when the NCR receives indicated TCI state in the DCI, it can determine whether this indicated TCI state is in the applicable TCI states for the backhaul link.

Implementation Example 5: HARQ-ACK Feedback for PDCCH Carrying Side Control Information

Side control information including at least one of: beam information, on/off information, power control information, timing information, or UL/DL time division duplex (TDD) configuration. The side control information can be indicated in the DCI and can be transmitted from the BS to the NCR. In order to guarantee the reliability of side control information, the HARQ-ACK feedback for the DCI can be needed. As for when and where to send the HARQ-ACK feedback of the DCI carrying the side control information, at least one of following options can be considered.

Op 1: the BS may send a DCI format carrying the side control information ending in slot n. The NCR can report the HARQ-ACK feedback information over the PUCCH transmission that is nearest to slot n.

Op 2: the BS may send a DCI format carrying the side control information ending in slot n. The NCR can report the HARQ-ACK feedback information over the PUCCH transmission in slot n+k, where k can be a time offset value provided by the BS to the NCR.

Op 3: the BS may send a DCI format carrying the side control information ending in slot n, the NCR can report the HARQ-ACK feedback information over the PUCCH transmission in slot n+L, where L can be provided by the current “PDSCH-to-HARQ_feedback timing indicator” field in the DCI.

It should be understood that one or more features from the above implementation examples are not exclusive to the specific implementation examples, but can be combined in any manner (e.g., in any priority and/or order, concurrently or otherwise).

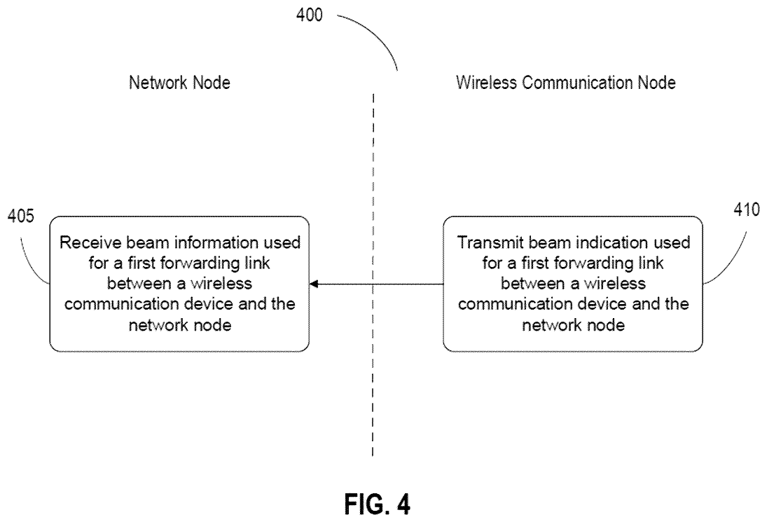

FIG. 4 illustrates a flow diagram for identifying beams and associated time, in accordance with an embodiment of the present disclosure. The method 400 may be implemented using any one or more of the components and devices detailed herein in conjunction with FIGS. 1-2. In overview, the method 400 may be performed by a network node, in some embodiments. Additional, fewer, or different operations may be performed in the method 400 depending on the embodiment. At least one aspect of the operations is directed to a system, method, apparatus, or a computer-readable medium.

At least one aspect is directed to a system, method, apparatus, or a computer-readable medium of the following.

A network node (e.g., a secondary node (SN)) may receive beam information used for a first forwarding link (e.g., an access link) between a wireless communication device and the network node, from a wireless communication node (e.g., a BS). The beam information can be associated with a plurality of beams. The beams for the network node on the first forwarding link may include a first type of beams and a second type of beams. The beam information may include at least one of following information: a beam index; a beam pattern index; a bit flag to indicate the beam index or the beam pattern index; or a beam number. The beam number can be used to indicate the number of beams in each indication.

In some embodiments, the beam index may include at least one of an index of the first type of beams, an index of the second type of beams or the bit flag to differentiate the first type of beams or second type of beams.

In some embodiments, the network node may receive a list from the wireless communication node. The list may include one or a plurality of beam information and one or a plurality of associated time information. The list can be indicated to the network node by at least one of RRC signaling, MAC CE, or DCI signaling. A new field can be added in the DCI signaling to indicate the beam information and associated time information simultaneously. One of existing fields in the DCI signaling can be reused to indicate the beam information and associated time information simultaneously.

In some embodiments, one of existing bits in the DCI signaling or a newly added bit in the DCI signaling can be used to indicate whether the existing field is for a legacy use or for the beam information and associated time information. The associated time information of beam can be indicated to the network node.

In some embodiments, the beam information and the associated time information can be indicated to the network node via a same signaling or different signalings. A new field can be added in a DCI signaling to indicate the beam information for the first forwarding link. One of existing fields in a DCI signaling can be reused to indicate the beam information for the first forwarding link. One of existing bits in a DCI signaling or a newly added bit in the DCI signaling can be used to differentiate indicate whether the existing field is for a legacy use or for the beam information for the first forwarding link.

In some embodiments, a new field can be added in a DCI signaling to indicate the associated time information for the first forwarding link. One of existing fields in a DCI signaling can be reused to indicate the associated time information for the first forwarding link. One of existing bits in the DCI signaling or a newly added bit in the DCI signaling can be used to indicate whether the existing field is for a legacy use or the associated time information for the first forwarding link.

In some embodiments, a wireless communication node may transmit beam indication used for a first forwarding link between a wireless communication device and a network node, to the network node. The beam indication can be associated with a plurality of beams.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a network node, a first signaling from a wireless communication node, wherein the first signaling comprises a list of forwarding resources, each of the list of forwarding resources comprises a beam index and a time resource associated with the beam index; and
receiving, by the network node, a second signaling from the wireless communication node, wherein the second signaling indicates at least one forwarding resource used for an access link between a wireless communication device and the network node from the list of the forwarding resources.

2. The wireless communication method of claim 1, further comprising receiving, by the network node, the first signaling via a RRC signaling, and receiving, by the network node, the second signaling via MAC CE signaling.

3. The wireless communication method of claim 1, wherein the time resource includes a start time and a duration, the start time of the time resource is indicated via a start symbol and a start slot, and the duration of the time resource is indicated via a symbol number.

4. The wireless communication method of claim 1, wherein the second signaling further indicates a beam index associated with the at least one forwarding resource.

5. A wireless communication method, comprising:
transmitting, by a wireless communication node, a first signaling to a network node, wherein the first signaling comprises a list of forwarding resources, each of the list of forwarding resources comprises a beam index and a time resource associated with the beam index; and
transmitting, by the wireless communication node, a second signaling to the network node, wherein the second signaling indicates at least one forwarding resource used for an access link between a wireless communication device and the network node from the list of the forwarding resources.

6. The wireless communication method of claim 5, further comprising transmitting, by the wireless communication node, the first signaling via a RRC signaling, and transmitting, by the wireless communication node, the second signaling via MAC CE signaling.

7. The wireless communication method of claim 5, wherein the time resource includes a start time and a duration, the start time of the time resource is indicated via a start symbol and a start slot, and the duration of the time resource is indicated via a symbol number.

8. The wireless communication method of claim 5, wherein the second signaling further indicates a beam index associated with the at least one forwarding resource.

9. A wireless communication apparatus comprising at least one processor and a memory, wherein the at least one processor is configured to read code from the memory and implement a method that causes the wireless communication apparatus to:
receive, by a network node, a first signaling from a wireless communication node, wherein the first signaling comprises a list of forwarding resources, each of the list of forwarding resources comprises a beam index and a time resource associated with the beam index; and
receive, by the network node, a second signaling from the wireless communication node, wherein the second signaling indicates at least one forwarding resource used for an access link between a wireless communication device and the network node from the list of the forwarding resources.

10. The wireless communication apparatus of claim 9, wherein the at least one processor further configures the wireless communication apparatus to:
receive, by the network node, the first signaling via a RRC signaling, and receiving, by the network node, the second signaling via MAC CE signaling.

11. The wireless communication apparatus of claim 9, wherein the time resource includes a start time and a duration, the start time of the time resource is indicated via a start symbol and a start slot, and the duration of the time resource is indicated via a symbol number.

12. The wireless communication apparatus of claim 9, wherein the second signaling further indicates a beam index associated with the at least one forwarding resource.

13. A wireless communication apparatus comprising at least one processor and a memory, wherein the at least one processor is configured to read code from the memory and implement a method that causes the wireless communication apparatus to:
transmit, by a wireless communication node, a first signaling to a network node, wherein the first signaling comprises a list of forwarding resources, each of the list of forwarding resources comprises a beam index and a time resource associated with the beam index; and
transmit, by the wireless communication node, a second signaling to the network node, wherein the second signaling indicates at least one forwarding resource used for an access link between a wireless communication device and the network node from the list of the forwarding resources.

14. The wireless communication apparatus of claim 13, wherein the at least one processor further configures the wireless communication apparatus to:
transmit, by the wireless communication node, the first signaling via a RRC signaling, and transmitting, by the wireless communication node, the second signaling via MAC CE signaling.

15. The wireless communication apparatus of claim 13, wherein the time resource includes a start time and a duration, the start time of the time resource is indicated via a start symbol and a start slot, and the duration of the time resource is indicated via a symbol number.

16. The wireless communication apparatus of claim 13, wherein the second signaling further indicates a beam index associated with the at least one forwarding resource.
